(19) United States
(12) Patent Application Publication
(10) Pub. No.: US 2026/0304342 A1
(43) Pub. Date: Oct. 1, 2026

(54) DYNAMIC ROAMING PROFILE MANAGEMENT

(71) Applicant: T-MOBILE INNOVATIONS LLC, Overland Park, KS (US)

(72) Inventors: Shrivastava Rajesh GOVINDPRASAD, Bothell, WA (US); Neal Michael MURPHY, Bucyrus, KS (US); Janardhan M. THEPPASANDRA, Sammamish, WA (US)

(21) Appl. No.: 19/091,197

(22) Filed: Mar. 26, 2025

(51) Int. Cl. H04W 60/04; H04W 4/24; H04W 64/00

(52) U.S. Cl. CPC H04W 60/04; H04W 4/24; H04W 64/00

(57) ABSTRACT

Systems and methods are provided for dynamic roaming profile management. The system integrates a network provisioning engine (NPE) that utilizes an API call to a billing component/server. The NPE can serve as a gateway between the network and the billing component/server in order to access the most up-to-date, validated data regarding user equipment (UE) profiles including roaming profiles. This ensures that the UE is provisioned on a network using the correct roaming profile and does not receive services to which it is not subscribed.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for dynamic roaming profile management. More particularly, in aspects set forth herein, systems and methods enable a network provisioning engine (NPE) that can serve as a gateway between a telecommunication network and a billing server associated with the telecommunication network. Access to the up-to-date, validated data of the billing server allows the NPE to provision a user equipment (UE) correctly on the network. In other words, any services to which the UE is subscribed should be provisioned for the UE, while services to which the UE is not subscribed should not be provisioned on the network.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a flow diagram of a method for dynamic profile management, in accordance with aspects herein;

FIG. 3 depicts a flow diagram of a method for dynamic profile management, in accordance with aspects herein; and

FIG. 4 depicts a diagram of an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
AMF Access & Mobility Management Function
APN Access Point Name
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
PC Personal Computer
PCF Policy Control Function
PCS Personal Communications Service
PDA Personal Digital Assistant
RAM Random Access Memory
RET Remote Electrical Tilt
RF Radio-Frequency
RFI Radio-Frequency Interference
R/N Relay Node
ROM Read Only Memory
SINR Transmission-to-Interference-Plus-Noise Ratio
SMF Session Management Function
SNR Transmission-to-noise ratio
SON Self-Organizing Networks
TDMA Time Division Multiple Access
TXRU Transceiver (or Transceiver Unit)
UDM Unified Data Management Function
UDR Unified Data Repository
UE User Equipment
UPF User Plane Function

Further, various technical terms are used throughout this description. An illustrative resource that fleshes out various aspects of these terms can be found in Newton's Telecom Dictionary, 32d Edition (2022).

As used herein, the term “node” is used to refer to network access technology for the provision of wireless telecommunication services from a base station to one or more electronic devices, such as an eNodeB, gNodeB, etc.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunication networks employ a plurality of base stations (i.e., cell sites, cell towers) to provide network coverage. The base stations are employed to broadcast and transmit transmissions to user devices of the telecommunications network. An access point may be considered to be a portion of a base station that may comprise an antenna, a radio, and/or a controller.

As employed herein, a UE (also referenced herein as a user device) or WCD can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

The present disclosure is directed to dynamic management of roaming profiles. Aspects herein enable a network provisioning engine (NPE) that can serve as a gateway between a telecommunication network and a billing server associated with the telecommunication network. Access to up-to-date, validated data of the billing server allows the NPE to provision a UE correctly on the network. In other words, any services to which the UE is subscribed should be provisioned for the UE, while services to which the UE is not subscribed should not be provisioned on the network.

In a first aspect, the techniques described herein relate to a system for profile management, the system including: one or more processors; and one or more computer-readable media storing computer-usable instructions that, when executed by the one or more processors, cause the one or more processors to: receive a request to provision a user equipment (UE) to a network; generate a query to a billing component for a UE-specific roaming profile; and provision the network according to the UE-specific roaming profile received from the billing component.

In another aspect, the techniques described herein relate to a method for profile management, the method including: receiving a request to provision a user equipment (UE) to a network; generating a query to a billing component for a UE-specific roaming profile; and provisioning the network according to the UE-specific roaming profile received from the billing component.

In other aspects, the techniques described herein relate to a system for profile management, the system including: one or more processors; and one or more computer-readable media storing computer-usable instructions that, when executed by the one or more processors, cause the one or more processors to: receive a request to provision a user equipment (UE) to a network based on the UE being associated with a roaming location, wherein the roaming location is outside of a coverage area of the UE's original network; generate a query to a billing component for a UE-specific roaming profile; generate an updated roaming profile for the UE; and provision the network according to the updated roaming profile for the UE.

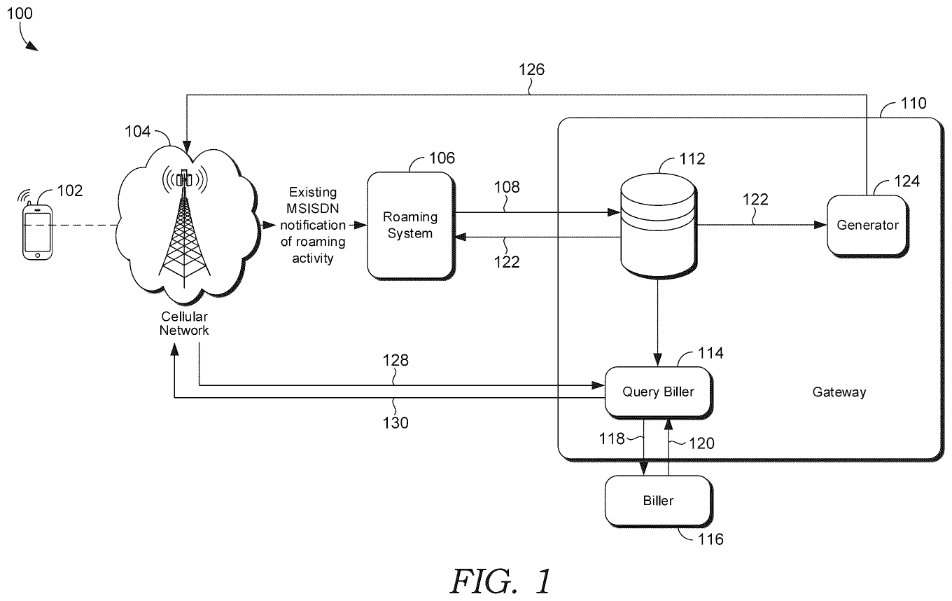

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

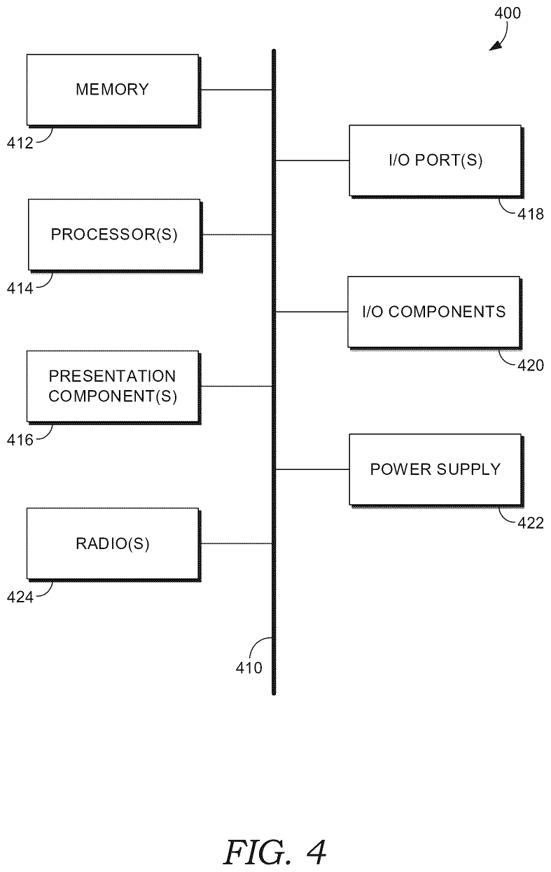

A network cell may comprise a base station to facilitate wireless communication between a communications device within the network cell, such as communications device 400 described with respect to FIG. 4, and a network. As shown in FIG. 1, communications device may be UE 102. In the network environment 100, UE 102 may communicate with other devices, such as mobile devices, servers, etc. The UE 102 may take on a variety of forms, such as a personal computer, a laptop computer, a tablet, a netbook, a mobile phone, a Smart phone, a personal digital assistant, or any other device capable of communicating with other devices. For example, the UE 102 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 102 comprises a wireless or mobile device with which a wireless telecommunication network(s) can be utilized for communication (e.g., voice and/or data communication). In this regard, the UE 102 can be any mobile computing device that communicates by way of, for example, a 5G network.

The UE 102 may utilize a network to communicate with other computing devices (e.g. mobile device(s), a server(s), a personal computer(s), etc.). In embodiments, the network is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. The network may include multiple networks. The network may be part of a telecommunications network that connects subscribers to their immediate service provider. In embodiments, the network is associated with a telecommunications provider that provides services to user devices, such as UE 102. For example, the network may provide voice services to user devices or corresponding users that are registered or subscribed to utilize the services provided by a telecommunications provider.

In practice, a UE is associated with what is referred to as a home network. A home network, as used herein, refers generally to a telecommunications network to which a UE is subscribed. When a UE is outside of their home network (or coverage area thereof), roaming occurs. While roaming, a UE connects to a network different than its home network (may be referred to herein as a roaming network) in order to utilize the services to which it subscribes (e.g., voice, data, etc.). UE's may be provisioned on a roaming network automatically when leaving their home network. Sometimes when roaming, services do not work as expected, which leads to a user to contact a customer services specialist/department. Customer service prioritizes customer satisfaction and aims to correct issues for the users. However, currently customer service seeks to correct issues for users without validating said correction. Put simply, a user may report frustrations with data usage while roaming but, in fact, not subscribe to data at all while roaming. By way of another example, a user may report slow data while roaming but subscribe to a plan that throttles data usage after a predetermined threshold. In each of these examples, a user is frustrated but, in reality, is experiencing the service to which he/she subscribes.

Customer service agents may seek to correct this frustration by fixing an issue that is not really an issue. Returning to the previous examples, customer service may turn on data for the customer that does not subscribe to data in a roaming network or, in the other example, the customer service agent may increase the data for the user that has a throttled data allocation. The users, in those instances, are receiving services for which they are not paying. Further, customer service agents are potentially modifying the UE provisioning without any sort of validation of data.

In telecommunication networks, the billing system can be a “final source of truth” to which data may be validated. In simple terms, customers should receive the services for which they are charged and should not receive services for which they are not charged/paying.

Aspects of the present disclosure seek to provide dynamic management of roaming profiles. A roaming profile, as used herein, is a UE-specific profile that indicates services to which the UE should be provisioned in a roaming network. These services may include data, voice, text, etc. As shown in FIG. 1, the environment 100 includes a UE 102 that is attempting to connect to network 104 and be provisioned. For purposes of this description, network 104 is a network other than the UEs 102 home network (e.g., a roaming network). As shown, there are two aspects to which the present solution may be initiated. A first (top portion of the diagram) is automatic while the second (bottom portion of the diagram) is manually initiated by the user or UE 102. In either case, the UE 102 may be identified by the network 104 using any known UE identifier including a phone number, a mobile station international subscriber directory number (MSISDN), and the like.

The automatic initiation of the process (i.e., automatic initiation of a roaming provisioning check) may begin by detecting that the UE 102 is in a location outside of the coverage area of their home network (i.e., a roaming location). Another network, such as network 104, that offers coverage to the current location of the UE 102 is identified and associated as the roaming network for the UE 102. This determination that roaming is occurring is communicated to a roaming system 106. At this point, a network provisioning engine (NPE) 110 or a gateway is contacted. At step 108, the check or validation of data provided herein is initiated and a rules engine 112 is contacted by the roaming system 106. The rules engine 112 receives the request to be provisioned (e.g., the check or validation of data) and generates a query for a billing server/component 116 at block 114 that is communicated to the billing server 116 at step 118 via an application programming interface (API) call to the billing server 116. The billing server 116 responds with a UE-specific roaming profile for the UE 102 and communicates that back to the NPE at step 120. The UE-specific roaming profile comprises parameters to which the network should be provisioned for the UE 102 such as voice, data, and text. A UE-specific roaming profile provision instruction (or an updated UE-specific roaming profile) is generated by generator 124 and used to provision the network at step 126. The UE-specific roaming profile can be used to provision the network 104 at step 126 or can be compared to a current roaming profile being implemented at the network 104 for the UE 102 (e.g., identifying if the two profiles match one another). In the event the updated UE-specific roaming profile differs from the current roaming profile, the current roaming profile is overridden by the updated UE-specific roaming profile. Thus, the network overrides a current roaming profile and implements the updated UE-specific roaming profile from the billing component 116.

Another aspect provides for manual initiation of the process (bottom half of the diagram). A manual initiation can be communicated at step 128 to the NPE 110. The NPE 110 performs the same steps described above with the automated process. Specifically, the rules engine 112 identifies the request for provisioning and generates a query for the billing server 116. The billing server 116 provides the UE-specific roaming profile for the UE 102 back to the NPE 110 and that is used by the generator 124 to generate instructions to provision the network at step 126. Additionally, at step 130, the NPE 110 notifies the UE 102 that the roaming profile has been implemented. That can refer to a situation where either the current roaming profile was accurate and is implemented or the current roaming profile was inaccurate and was overridden by an updated roaming profile.

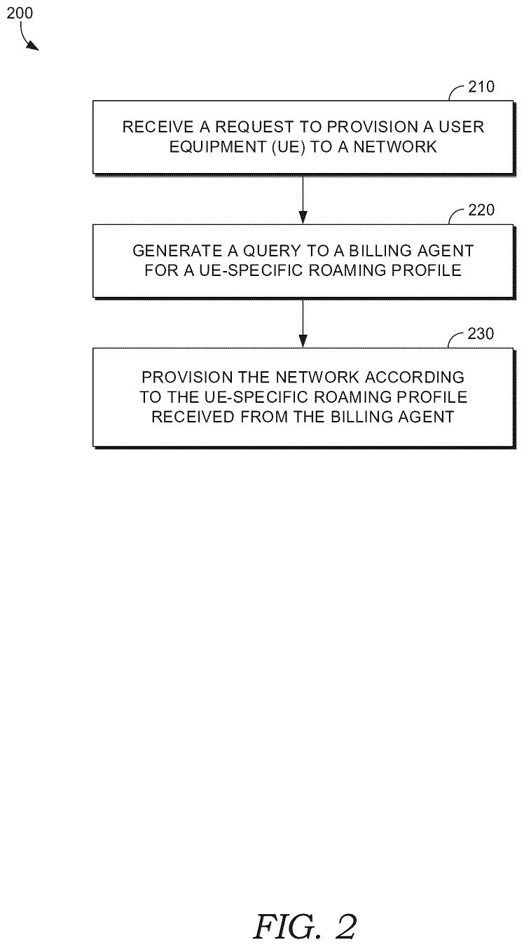

Turning to FIG. 2, a flow diagram 200 is provided illustrating a flow to manage roaming profiles. At block 210, a request to provision a user equipment (UE) to a network is received. A query to a billing component is generated that requests a UE-specific roaming profile for the UE at block 220. At block 230, the network is provisioned according to the UE-specific roaming profile received from the billing component.

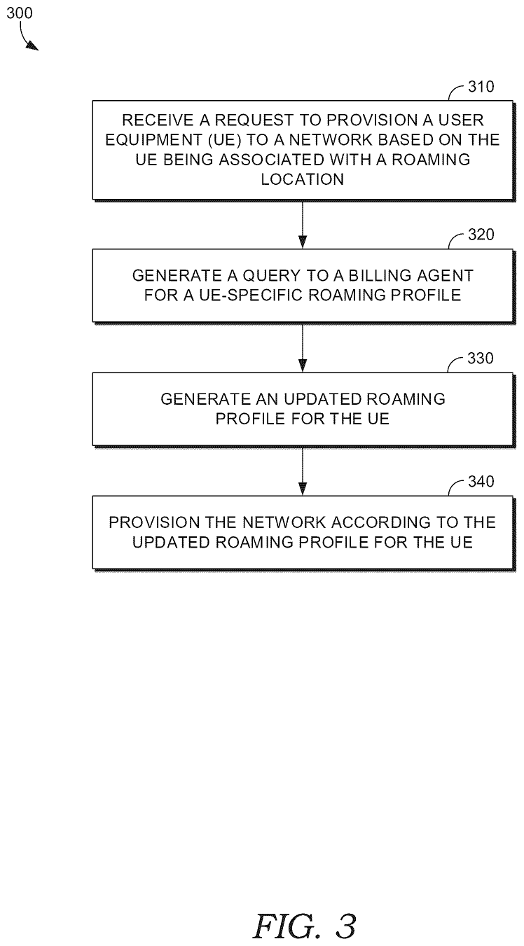

Referring to FIG. 3, a flow diagram 300 is provided illustrating a flow to manage roaming profiles. At block 310, a request is received to provision a user equipment (UE) to a network based on the UE being associated with a roaming location. In aspects, the roaming location is outside of a coverage area of the UE's original network. At block 320, a query is generated to a billing component for a UE-specific roaming profile. At block 330, an updated roaming profile is generated for the UE. The UE is provisioned on the network according to the updated roaming profile for the UE at block 340.

Referring to FIG. 4, a block diagram of an exemplary computing device 400 suitable for use in implementations of the technology described herein is provided. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated. It should be noted that although some components in FIG. 4 are shown in the singular, they may be plural. For example, the computing device 400 might include multiple processors or multiple radios. In aspects, the computing device 400 may be a UE/WCD, or other user device, capable of two-way wireless communications with an access point. Some non-limiting examples of the computing device 400 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 4, computing device 400 includes a bus 410 that directly or indirectly couples various components together, including memory 412, processor(s) 414, presentation component(s) 416 (if applicable), radio(s) 424, input/output (I/O) port(s) 418, input/output (I/O) component(s) 420, and power supply(s) 422. Although the components of FIG. 4 are shown with lines for the sake of clarity, in reality, delineating various components is not so clear, and metaphorically, the lines would more accurately be grey and fuzzy. For example, one may consider a presentation component such as a display device to be one of I/O components 420. Also, processors, such as one or more processors 414, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 412 may take the form of memory components described herein. Thus, further elaboration will not be provided here, but it should be noted that memory 412 may include any type of tangible medium that is capable of storing information, such as a database. A database may be any collection of records, data, and/or information. In one embodiment, memory 412 may include a set of embodied computer-executable instructions that, when executed, facilitate various functions or elements disclosed herein. These embodied instructions will variously be referred to as “instructions” or an “application” for short.

Processor 414 may actually be multiple processors that receive instructions and process them accordingly. Presentation component 416 may include a display, a speaker, and/or other components that may present information (e.g., a display, a screen, a lamp (LED), a graphical user interface (GUI), and/or even lighted keyboards) through visual, auditory, and/or other tactile cues.

Radio 424 represents a radio that facilitates communication with a wireless telecommunications network. Illustrative wireless telecommunications technologies include CDMA, GPRS, TDMA, GSM, and the like. Radio 424 might additionally or alternatively facilitate other types of wireless communications including Wi-Fi, WiMAX, LTE, 3G, 4G, LTE, mMIMO/5G, NR, VoLTE, or other VoIP communications. As can be appreciated, in various embodiments, radio 424 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 418 may take a variety of forms. Exemplary I/O ports may include a USB jack, a stereo jack, an infrared port, a firewire port, other proprietary communications ports, and the like. Input/output (I/O) components 420 may comprise keyboards, microphones, speakers, touchscreens, and/or any other item usable to directly or indirectly input data into the computing device 400.

Power supply 422 may include batteries, fuel cells, and/or any other component that may act as a power source to supply power to the computing device 400 or to other network components, including through one or more electrical connections or couplings. Power supply 422 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system for profile management, the system comprising:
one or more processors; and
one or more computer-readable media storing computer-usable instructions that, when executed by the one or more processors, cause the one or more processors to:
receive a request to provision a user equipment (UE) to a network;
generate a query to a billing component for a UE-specific roaming profile; and
provision the network according to the UE-specific roaming profile received from the billing component.

2. The system of claim 1, wherein provisioning the network comprises overriding a current roaming profile of the UE.

3. The system of claim 1, wherein provisioning the network comprises implementing a current roaming profile of the UE.

4. The system of claim 3, wherein the current roaming profile is implemented when the billing component provides the UE-specific roaming profile and it matches the current roaming profile for the UE.

5. The system of claim 1, further comprising comparing a current roaming profile to the UE-specific roaming profile from the billing component.

6. The system of claim 1, further comprising generating an updated roaming profile to provision the network, wherein the updated roaming profile overrides a current roaming profile.

7. The system of claim 1, wherein the request is received from a UE based on an automatic initiation of a roaming provisioning check when the UE is determined to be in a roaming location.

8. The system of claim 1, wherein the request is received based on a manual initiation at the UE.

9. A method for profile management, the method comprising:
receiving a request to provision a user equipment (UE) to a network;
generating a query to a billing component for a UE-specific roaming profile; and
provisioning the network according to the UE-specific roaming profile received from the billing component.

10. The method of claim 9, wherein provisioning the network comprises overriding a current roaming profile of the UE.

11. The method of claim 9, wherein provisioning the network comprises implementing a current roaming profile of the UE.

12. The method of claim 11, wherein the current roaming profile is implemented when the billing component provides the UE-specific roaming profile and it matches the current roaming profile for the UE.

13. The method of claim 9, further comprising comparing a current roaming profile to the UE-specific roaming profile from the billing component.

14. The method of claim 9, further comprising generating an updated roaming profile to provision the network, wherein the updated roaming profile overrides a current roaming profile.

15. The method of claim 9, wherein the request is received from a UE based on an automatic initiation of a roaming provisioning check when the UE is determined to be in a roaming location.

16. The method of claim 9, wherein the request is received based on a manual initiation at the UE.

17. A system for profile management, the system comprising:
one or more processors; and
one or more computer-readable media storing computer-usable instructions that, when executed by the one or more processors, cause the one or more processors to:
receive a request to provision a user equipment (UE) to a network based on the UE being associated with a roaming location, wherein the roaming location is outside of a coverage area of an original network;
generate a query to a billing component for a UE-specific roaming profile;
generate an updated roaming profile for the UE; and
provision the network according to the updated roaming profile for the UE.

18. The system of claim 17, wherein the updated roaming profile overrides a current roaming profile for the UE.

19. The system of claim 17, wherein provisioning the network comprises overriding a current roaming profile with the updated roaming profile.

20. The system of claim 17, wherein the UE-specific roaming profile is identified utilizing a UE identifier, wherein the UE identifier is a mobile station international subscriber directory number (MSISDN).
